(19) United States
(12) Patent Application Publication
(10) Pub. No.: US 2004/0211217 A1
(43) Pub. Date: Oct. 28, 2004

(54) Method of regenerating pressing molds and method of manufacturing optical elements

(75) Inventor: Shigeaki Ohmi, Tokorozawa-shi (JP)

Correspondence Address: OBLON, SPIVAK, MCCLELLAND, MAIER & NEUSTADT, P.C., 1940 DUKE STREET, ALEXANDRIA, VA, 22314, US

(73) Assignee: HOYA CORPORATION, Tokyo (JP)

(21) Appl. No.: 10/658,467

(22) Filed: Sep. 10, 2003

(30) Foreign Application Priority Data
Sep. 11, 2002 (JP) 2002-264959

(51) Int. Cl. B29C 33/60; B29C 33/72; C03B 40/02

(52) U.S. Cl. 65/26; 264/39; 264/338

(57) ABSTRACT

Disclosed is a method of regenerating a pressing mold comprising removal of a carbon-based film from a pressing mold having the film on a molding surface thereof. The removal of the film is performed by etching with plasma of a hydrogen-based gas or treatment with UV ozone. Disclosed is a method of manufacturing an optical glass element comprising press molding of a heat-softened glass material in a pressing mold having a carbon-based film on a molding surface thereof. The pressing mold is that has been regenerated by removing a carbon-based film on the pressing mold having the film on the molding surface thereof by hydrogen gas plasma etching or UV ozone treatment, after which a carbon-based film has been formed on the molding surfaces from which the film has been removed. Provide is a method of regeneration that removes the carbon-based film on the molding surface of the base material of a pressing mold without damaging the surface of the base material of the pressing mold and that can reliably remove carbon-based films at reduced cost and in less time. Provide is a method of manufacturing optical glass elements employing a pressing mold that has been regenerated by this method.

### TECHNICAL FIELD

The present invention relates to a method of regenerating pressing molds suited to the removal and regeneration of deteriorated films on the molding surface of optical element pressing molds employed in the manufacturing of glass optical elements such as lenses and prisms by the press molding of glass materials, and to a method of manufacturing optical glass elements employing a pressing mold that has been regenerated by the method of regenerating pressing molds.

### BACKGROUND ART

It is known that a carbon-based film as a mold separation film is provided on the molding surfaces of a pressing mold for optical glass elements.

This mold separation film is extremely useful because, as the glass comes into close contact with molding surfaces at high temperature during pressing, the mold separation film prevents fusion, maintains a mirror surface on precision-processed molding surfaces, and maintains sliding properties between the molding surface and the glass when the glass is extended at high temperature. Carbon-based mold separation films in particular afford the advantages of low cost and good performance.

However, when a large number of pressing cycles is conducted, the mold separation film partially separates, is lost, or the like, becoming worn down and no longer adequately performing its function. When pressing is continued still further, the glass fuses to the molding surfaces, reacts with the base material of the mold, and damages the mold. Expensive molds in which the special base material of the mold has been precisely processed to form the molding surface are employed. When the above-described damage is imparted, the mold can no longer be used. Accordingly, the performance of the mold separation film must be continuously checked. To repair deterioration of this film, it is necessary to conduct a regeneration operation by removing the film after a prescribed number of pressing cycles following formation of the mold separation film and forming a new film. This makes it possible to both constantly press mold optical elements with high surface precision and extend the service life of the base material of the mold.

As a conventional optical element forming mold regeneration method, Japanese Unexamined Patent Publication (KOKAI) Heisei No. 2-38330 (Patent Reference 1) describes a method of regenerating pressing molds in which, after eliminating by oxygen plasma ashing the hard carbon film on a glass pressing mold having a hard carbon-film on its molding surface, an aqueous solution of hydrogen fluoride or a salt thereof is used to cleanse the molding surface of the pressing mold. Further, Japanese Unexamined Patent Publication (KOKAI) Heisei No. 6-345447 (Patent Reference 2) describes a method of regenerating pressing molds by which, following the elimination of the carbon-based film of a glass pressing mold having a carbon-based film on its molding surfaces by reduced pressure plasma etching with a fluorine-based gas or a mixed gas of fluorine-based gas and oxygen, the residual adhered matter remaining by diffusion of the components in the glass is removed by scrubbing with abrasive grains of minute diameter. Japanese Patent Publication No. 2505893 (Patent Reference 3) describes a method of regenerating pressing molds in which a portion of the film is etched with a plasma of oxygen-containing gas, and before the base material of the mold is etched, it is switched to etching with argon gas plasma to remove the film.

As stated in Patent Reference 1, when a hard carbon film is removed by oxygen plasma ashing alone, the surface of the base material is eroded by the oxygen plasma and a modified layer in the form of an oxide layer is formed on the surface of the base material. When a carbon-based film is formed on such the surface, the carbon-based film adheres only weakly to the surface of the base material. And during press molding thereafter, there are problems such as separation of the carbon-based coating. Accordingly, a method of cleansing the molding surface of the pressing mold with an aqueous solution of hydrogen fluoride or a salt thereof is described. This cleansing treatment is capable of removing the modified layer on the surface of the base material. However, this removal slightly roughens the surface of the base material. With repeated regeneration of the pressing mold, this surface roughening accumulates. It is transferred during pressing, resulting in problems in the form of a defective external appearance in the form of clouding and fogging due to optical scattering resulting from the roughness of the surface of the press molded product.

Patent Reference 2 describes a scrubbing method employing a diamond paste with an average particle diameter of 0.5 μm following plasma etching. However, in this method, an oxide layer and a fluoride layer are produced on the surface of the base material. Even when scrubbing removes the volatile components of the glass remaining on the molding surface, it is impossible to remove the modified layer such as the oxide layer and fluoride layer and roughness on the surface of the base material since the base material is hard.

In the method described in Patent Reference 3, to prevent erosion of the surface of the base material by plasma, before etching the base material of the mold, a switch is made from ashing or etching by oxygen gas plasma to ashing or etching by argon gas plasma to remove the film. However, this method requires judgment of when to make the switch. Determining when to make the switch requires additional equipment and steps such as etching while monitoring the intensity of light emitted by the etching compound by plasma light-emission analysis, thus increasing cost. Further, the cost of etching is doubled by using two plasmas, one of oxygen gas and the other of argon gas.

As set forth above, conventional methods do not regenerate optical element pressing molds with good precision and economy.

Accordingly, the object of the present invention is to provide a method of regeneration that removes the carbon-based film on the molding surface of the base material of a pressing mold without damaging the surface of the base material of the pressing mold and that can reliably remove carbon-based films at reduced cost and in less time.

The present invention further provides a method of manufacturing optical glass elements employing a pressing mold that has been regenerated by this method.

### DISCLOSURE OF THE INVENTION

To solve the above-described problems, the present invention is a method of regenerating pressing molds comprising the removal of a carbon-based film from a pressing mold having the film on the molding surface thereof, characterized in that the removal of the film is performed by etching with the plasma of a hydrogen-based gas or treatment with UV ozone.

In the present invention, it is desirable for (1) the hydrogen-based gas to be hydrogen gas or a mixed gas of hydrogen gas and argon gas; (2) the pressing mold having a carbon-based film on the molding surface thereof to be heated to greater than or equal to 100° C. and less than or equal to 600° C. during the UV ozone treatment; (3) the molding surfaces to be cleansed with an acid solution or an alkali solution prior to conducting plasma etching or UV ozone treatment; (4) a further step of forming a carbon-based film on the molding surface from which the film has been removed to be included; and (5) the pressing mold that is subjected to the etching or UV ozone treatment to have a deteriorated film.

The present invention further relates to a method of manufacturing optical glass elements comprising the press molding of a heat-softened glass material in a pressing mold having a carbon-based film on the molding surface thereof, characterized in that the pressing mold has been regenerated by removing by hydrogen-based gas plasma etching or UV ozone treatment of a carbon-based film on the pressing mold having the film on the molding surface thereof, after which a carbon-based film has been formed on the molding surfaces from which the film has been removed.

In the present invention, the carbon-based film of the pressing mold that is subjected to etching or UV ozone treatment has desirably deteriorated.

### BRIEF DESCRIPTION OF THE FIGURES

FIG. 1 is a descriptive drawing of a pressing mold with a carbon-based film formed on the molding surfaces thereof.

FIG. 2 is a descriptive drawing of a plasma processing device.

FIG. 3 is a descriptive drawing of a UV ozone treatment device.

### BEST MODE OF IMPLEMENTING THE INVENTION

The present invention is a method of regenerating pressing molds comprising the step of removing a carbon-based film from a pressing mold having the film on the molding surfaces thereof.

The pressing mold that is regenerated by the method of the present invention has a carbon-based film on the molding surface thereof. The material employed as the base material of the mold is selected on the basis of the possibility of processing into an optical mirror surface, whether it has mechanical strength capable of withstanding press impact, and the like.

Examples of materials that can be selected from such perspectives are SiC, WC, TiC, TaC, BN, TiN, AlN, Si₃N₄, SiO₂, Al₂O₃, ZrO₂, W, Ta, Mo, cermet, syalon, mullite, carbon composite (C/C), carbon fiber (CF), WC—Co alloy, stainless steel, and the like. In particular, pressing molds having a mold base material in the form of SiC, WC, TiC, TaC, WC—Co alloy, and stainless steel are highly reactive with oxygen and fluorine and have surfaces that tend to be modified or damaged by the etching of conventional methods employing oxygen and fluorine. However, since the selection ratio stated further below works advantageously when the present invention is applied, marked results by the present invention are achieved.

In the course of precision processing of the molding surface, the roughness of the molding surface is desirably less than or equal to 80 nm, preferably less than or equal to 50 nm, as an Rmax evaluated by measurement with atomic force microscopy (AFM).

Carbon-based films applied to the molding surfaces are films comprising carbon as primary component and examples are diamond-like carbon films (DLC films hereinafter), hydrogenerated diamond-like carbon films (DLC:H hereinafter), tetrahedral amorphous carbon films (ta-C hereinafter), hydrogenerated tetrahedral amorphous carbon films (ta-C:H hereinafter), amorphous carbon films (a-C hereinafter), and hydrogenerated amorphous carbon films (a-C:H hereinafter). However, the present invention is not limited to these carbon-based films.

Laminates of two or more of these films and composite films (where multiple film forming methods are applied simultaneously) may also be employed. These carbon-based films function to enhance the mold separability of the molding surfaces.

[Etching with the Plasma of a Hydrogen-Based Gas]

In the first aspect of the method of regenerating pressing molds of the present invention, the film on the pressing mold is removed by etching with the plasma of a hydrogen-based gas.

Etching with the plasma of a hydrogen-based gas affords the advantage of removing the carbon-based film without damaging the surface of the base material.

Here, the term “hydrogen-based gas” refers to a gas containing hydrogen, desirably a gas containing greater than or equal to 1 vol % of hydrogen, preferably a gas containing greater than or equal to 3 vol % of hydrogen. More specifically, hydrogen gas or a mixed gas of hydrogen gas and argon gas is employed as the hydrogen-based gas. The mixed gas with argon gas desirably contain greater than or equal to 1 vol % of hydrogen gas, preferably greater than or equal to 3 vol % of hydrogen.

The term “etching” refers to a method of removing the surface layer by means of a chemical reaction and includes ashing. The term “plasma” is a state in which charged particles produced by ionization are present in a gas, and includes mixed gases of ions and radicals and gases comprised chiefly of ions and radicals.

Etching by hydrogen-based gas plasma can be conducted with a known device by a method such as reactive ion etching or direct plasma. Such devices can be obtained in the form of commercial products. The etching conditions are suitably selected based on the device employed. The standard condition is a plasma output of 100 to 2,000 W. When the plasma output is either too high or too low, the plasma sometimes does not stabilize. The base plate temperature can be made from room temperature to 300° C.; when excessively high, the selection ratio described further below decreases, and when excessively low, the etching rate tends to drop. When ordinary pressure is employed in an ordinary pressure plasma processing device and when a gas pressure of about from 1 Pa to 100 KPa is employed in a reduced-pressure plasma processing device, stable plasma can be generated.

The etching with the plasma of a hydrogen-based gas that is employed in the present invention is characterized by high selectivity of the substance to be etched. Generally, the ratio of the etching rate of the film to that of the base material is called the selection ratio. Hydrogen has an etching rate for carbon that is comparable to that of the oxygen and CF₄ employed in conventional art, but has a quite low etching rate for the base material of the mold. For example, when the mold base material is SiC or WC, the etching rate by the plasma of a hydrogen-based gas is about 1/100^{th} that when a plasma of oxygen or CF₄ is employed. This is because of the low reactivity of hydrogen plasma with the mold base material; any reaction layer generated by the mold base material and hydrogen is extremely thin.

Accordingly, the use of hydrogen-based gas is characterized by an increase in the selection ratio so that even when etching processing is conducted in a manner exceeding what is necessary to completely remove the film, the surface of the base material remains essentially unmodified. That is, once the carbon-based film has been removed by etching, the mold base material is not etched even when the hydrogen-based plasma comes in contact with the base material of the mold. Thus, even when the etching period is longer than necessary, there is an advantage in that the base material is not modified or damaged. Further, in the event that a reaction layer is produced on the surface of the base material, it is a hydrogen-modified layer and does not impede adhesion of the film when forming a new carbon-based film during regeneration.

[UV Ozone Treatment]

In the second aspect of the method of regenerating pressing molds of the present invention, the film on the pressing mold is removed by UV ozone treatment.

The term “UV ozone treatment” refers to a method of generating ozone with ultraviolet radiation and rapidly decomposing and volatizing organic contaminants through the oxidizing power of excited oxygen atoms generated by the decomposition of this ozone. This method is employed in ultraprecise cleansing, sterilization, and deodorizing. The oxidizing power of excited oxygen atoms is less than that of oxygen plasma; the carbon etching rate is about ½ to ⅛. The etching rate on the mold base material is less than or equal to 1/100. For example, when SiC or WC is employed as the mold base material and UV ozone treatment is conducted, the selection ratio (the etching rate on carbon-based film/the etching rate on mold base material) is about ten-fold that of the selection ratio of oxygen plasma and CF₄ plasma. This is because the oxidizing power of excited oxygen atoms on the mold base material in UV ozone treatment is low and the reaction layer with the mold base material, when one is generated, is extremely thin.

Since the thickness of the reaction layer is extremely thin (for example, the film thickness can be kept to less than or equal to 1 nm), there is no decrease in adhesion when reforming the carbon-based film. Further, since no chemicals are employed, little burden is placed on the environment. The power of the UV light source employed to generate UV ozone is desirably greater than or equal to 100 W, preferably greater than or equal to 200 W. Further, oxygen is necessary in the atmosphere. The oxygen concentration is desirably greater than or equal to 5 vol %, preferably greater than or equal to 10 vol %. The UV ozone treatment generally lasts for several minutes to several hours. The UV ozone treatment (the ultraviolet radiation ozone process) can be conducted with a known device.

To accelerate the decomposition and removal of the carbon-based film by UV ozone treatment in the method of the present invention, it is desirable to heat the base plate. However, when heating exceeds 600° C., with some base plates, the surface of the pressing mold is oxidized, the adhesive strength of the mold separation film during the formation of the new mold separation film is compromised, and regeneration of the mold separation film is sometimes prevented. Accordingly, the base plate is desirably heated to less than 600° C. during UV ozone treatment. Further, the base plate is preferably heated to less than or equal to 400° C. during UV ozone treatment. When the base plate is heated to a temperature of less than 100° C., the rate of decomposition and removal of the carbon-based film slows during UV ozone treatment, so heating of the base plate to greater than or equal to 100° C. in UV ozone treatment is desirable. It is unnecessary for the base plate temperature to be fixed; it is possible to vary the temperature by setting the base plate temperature high at the start of the UV ozone treatment and subsequently gradually lowering it.

The UV ozone treatment in the present invention affords the same advantage as etching by hydrogen-based gas plasma of high selectivity of the substance that is etched. That is, once the carbon-based film on the pressing mold has been removed, the base material of the pressing mold is not modified or damaged.

Trace amounts of glass or volatile components of glass and the like sometimes adhere to and remain on the carbon-based film on the molding surfaces of the pressing mold after continuous pressing. Among these, there are materials that tend not to be removed by hydrogen-based plasma etching or UV ozone treatment. Accordingly, in the present invention, the carbon-based film of the molding surface of the pressing mold is desirably cleansed in advance with an acid or alkali solution to remove material adhering to the surface.

Examples of acid solutions are 1 to 50 wt % concentrations of hydrofluoric acid, acid ammonium fluoride aqueous solutions, nitric acid, sulfuric acid, hydrochloric acid, and a mixture of nitric acid and sulfuric acid. Examples of alkali solutions are 5 to 70 wt % concentrations of sodium hydroxide aqueous solutions, potassium hydroxide aqueous solutions, and lithium hydroxide aqueous solutions. The period of immersion in the acid solution or alkali solution is from several minutes to several hours, and the temperature of the immersion solution is desirably from room temperature to around 50° C.

The method of regeneration of the present invention further comprises the formation of a carbon-based film on the surface of the base material from which the film has been removed.

The carbon-based film is the above-described carbon film. When forming the film, for example, diamond films can be formed by microwave plasma CVD, the hot filament method, the plasma jet method, electron cyclotron resonance plasma CVD, DC-plasma CVD, optical CVD, laser CVD and the like. DLC films and DLC:H films can be formed by microwave plasma CVD, hot filament CVD, the plasma jet method, electron cyclotron resonance plasma CVD, DC-plasma CVD, optical CVD, laser CVD, the ion-plating method and other ionization vapor deposition methods, sputtering, and the like. ta-C films and ta-C:H films can be formed by FCA (Filtered Cathodic Arc). a-C and a-C:H films can be formed by plasma CVD, ion-plating methods and other ionization vapor deposition methods, sputtering, and vapor deposition methods.

The thickness of the carbon-based film is desirably about from 1 nm to μm, preferably from 2 nm to 100 nm. When the film is too thin, an adequate mold separation property and durability cannot be achieved. When the film is too thick, there is a problem in that adhesion to the mold base material decreases.

In the regeneration method of the present invention, the pressing mold subjected to the etching or UV ozone treatment may have a deteriorated film. This regeneration method is also applicable to pressing molds having other films.

The regeneration method of the present invention is not limited to pressing molds employed for optical elements such as lenses, mirrors, gratings, and prisms, but can also be applied to pressing molds used for molded articles of glass and plastic that are not optical elements.

[Method of Manufacturing Optical Glass Elements]

The present invention includes a method of manufacturing optical glass elements comprising the step of press molding a heat-softened glass material in a pressing mold having a carbon-based film on the molding surface thereof. This method of manufacturing optical glass elements is characterized in that the pressing mold has been regenerated by removing a carbon-based film on a pressing mold having the film on the pressing surface thereof by etching with a hydrogen-based gas plasma or by UV ozone treatment, and then forming a carbon-based film on the molding surface from which the film has been removed. The method of removing the carbon-based film is identical to that described under the regeneration method of the present invention set forth above. Further, the carbon-based film is formed on the molding surface from which a film has been removed. The carbon-based film can also be formed by the same methods as described for the regeneration method of the present invention. Further, press molding of the heat-softened glass material can be conducted by known methods.

Neither the glass material nor the shape of the glass material that is press molded by a pressing mold applying the present invention is specifically limited. However, the effect of the present invention is marked in glass materials with which deterioration of the mold separation film tends to occur, that is, in glass materials requiring frequent regeneration of the mold separation film. For example, since water molecules tend to be picked up by the glass components of glass materials comprised of phosphate-based optical glass, reactivity with the mold separation film on the molding surface is high and deterioration of the mold separation film is rapid. Accordingly, frequent regeneration of the mold separation film becomes necessary and the effect of the present application is marked. Similarly, examples of highly reactive glasses are fluorophosphate-based and borate-based optical glasses.

Further, to suppress the reactivity of the above-mentioned highly reactive glasses, the glass material temperature is sometimes set low during pressing (for example, set to a temperature corresponding to a glass viscosity of 10^{7.5} to 10^{8.5} dPa·s). In such cases, the necessary thickness cannot be achieved without increasing the pressing load. The pressing load is usually about 30 to 300 kg/cm². However, for the above-mentioned highly reactive glass materials, a high load area (for example, from about 200 to 250 kg/cm²) is suitably applied within this range. However, the mold separation film is rapidly damaged by pressing in the high load area and the frequency of regeneration is high. Thus, the present invention is extremely advantageous for the regeneration of pressing molds employed in the pressing of glasses of high reactivity.

Further, for items with shapes tending to crack when the optical element is formed (such as biconvex lenses, biconcave lenses, and meniscus lenses in which the difference between the center thickness and the edge thickness of the lens is greater than or equal to 2) the thickness of the mold separation film is generally increased to prevent cracking. For example, the thickness of the mold separation film is set to about 30 to 100 nm. When such a mold separation film deteriorates, it is extremely important to efficiently and completely remove the mold separation film without damaging the base material. Thus, the application of the present invention to the regeneration of pressing molds having thick mold separation films is also extremely effective.

Further, even slight surface roughness of the mold separation film is not permitted in optical elements imposing strict surface roughness requirements on the molding surface, such as an Rmax of 20 nm or less. Thus, it is quite important to increase the frequency of regeneration of the mold separation film without causing deterioration of the mirror surface of the base material of the mold; the present invention is also efficiently applied in such cases.

In the press molding step, a glass material that has been heat softened to achieve a glass viscosity of less than or equal to 10⁹ dPa·s is press molded in a pressing mold. At that time, the glass material is fed into the interior of the pressing mold and the mold and glass material are both heated to the above-mentioned temperature prior to molding, after which press molding may be conducted (referred to as isothermal pressing). It is also acceptable to feed a glass material that has been heat softened outside the mold into the pressing mold and immediately conduct press molding. In the latter case, the temperature of the glass material can be set higher than the mold temperature (referred to as anisothermal pressing), thereby making it possible to set the temperature of the mold lower than in isothermal pressing. For example, it is possible to heat the glass material to a temperature corresponding to a glass viscosity of greater than or equal to 10⁶ and less than 10⁸ dPa·s. Further, the pressing mold may be heated to a temperature corresponding to a glass viscosity of greater than or equal to 10⁸ and less than 10¹¹ dPa·s. This method inhibits deterioration of the mold separation film, is advantageous to extending the service life of the base material of the mold, and reduces the time required for the mold heating cycle, improving productivity. In both of these pressing methods, the glass material following pressing is cooled to a temperature less than or equal to the transition point temperature while still in the mold, and then taken out from the mold.

The present invention as set forth above provides a method of quickly and inexpensively regenerating pressing molds yielding high precision molded articles by removing the film by hydrogen-based gas plasma etching or UV ozone treatment even when a carbon-based film of the pressing mold has been damaged by forming optical elements with a pressing mold the molding surfaces of which have been coated with the film.

### EXAMPLES

The present invention is described in detail below through Examples.

### Example 1

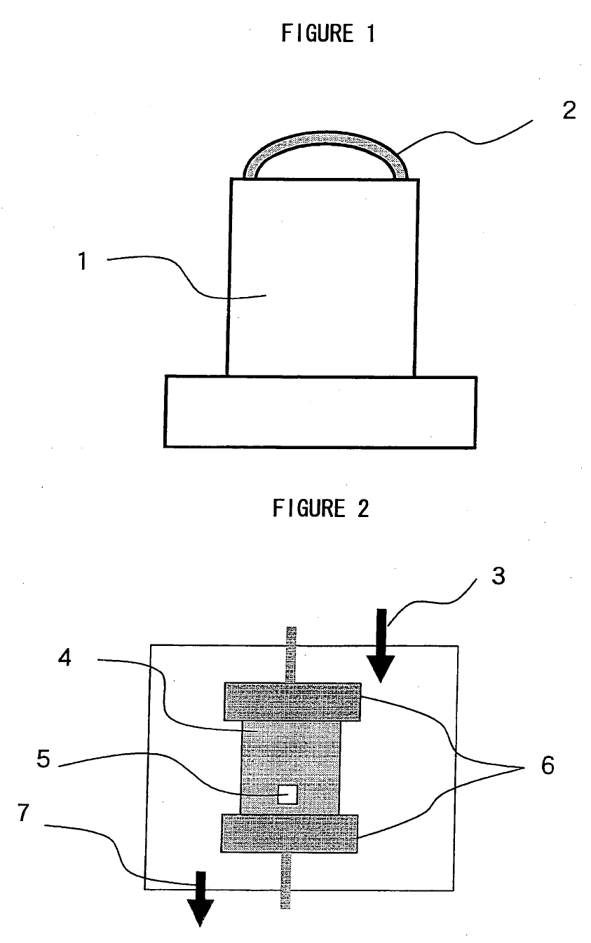

FIG. 1 shows an embodiment of an optical element pressing mold relating to the present invention. In FIG. 1, 1 denotes the base material of the mold and 2 denotes the carbon film (mold separation film) provided on the molding surfaces that mold the glass material.

The optical element pressing mold will be described in detail first. A mirror-surface mold base material with polycrystallized SiC molding surfaces formed by CVD that had been polished to Rmax=18 nm was employed (the roughness was measured by AFM). This mold was thoroughly cleansed, after which a DLC:H film was formed on the molding surface with an ion-plating film-forming device. Depth analysis by ESCA revealed the thickness of the DLC:H film to be 80 nm. Microscopic Raman analysis revealed two peaks near 1,380 cm⁻¹ (D-band) and near 1,580 cm⁻¹ (G-band) based on the medium-range order of disordered clusters and graphite clusters. The film structure was confirmed to be a DLC structure.

A spherical glass material (preform) of glass A (transition temperature Tg=500° C., yield point Ts=540° C.) of optical barium borosilicate glass adjusted to prescribed weight was placed in the cavity of a pressing mold and the pressing mold was positioned within a pressing device. Heating was conducted to 620° C. in a nitrogen gas atmosphere and pressure of 150 kg/cm² was applied for 1 min. Following the release of pressure, cooling was conducted at a rate of −50° C./min to 480° C., after which cooling was conducted at a rate of −100° C./min or greater. When the temperature of the press molded product had dropped to 200° C. or below, the molded product was retrieved. In this manner, a biconvex lens with an outer diameter of 12 mm φ, a center thickness of 1.5 mm, and an edge thickness of 0.5 mm was molded. In continuous molding, optical elements in the form of good molded products were obtained.

The molding surface was observed by optical microscopy after 1,000 molding cycles had been performed, revealing trace fusion adhesion of volatile material. Accordingly, immersion was conducted for 30 min in a 20% acid ammonium fluoride aqueous solution at room temperature. Following cleansing, the molding surfaces were observed by optical microscopy, revealing no trace fusion or adhesion of volatile matter and confirming removal by acid cleansing.

Next, the acid-cleansed optical element pressing mold was placed on the base plate in the chamber of a plasma processing unit such as is shown in FIG. 2. The interior of the chamber was evacuated to a vacuum of 5 Pa, and while introducing a mixed gas of 3.5% hydrogen and 96.5% argon into the chamber to 100 Pa, electricity was discharged to generate a plasma. Etching by hydrogen-based plasma was conducted for 20 min. Following etching, the molding surfaces were observed by optical microscopy and scanning electron microscopy (SEM), revealing no residue. The DLC:H film had been completely removed. Measurement of roughness by atomic force microscopy (AFM) revealed an Rmax of 19 nm. The surface profile of the base material molding surface had been preserved.

After thoroughly cleansing the optical element pressing mold following this treatment, an ion plating film-forming device was employed to form a DLC:H film to a thickness of 80 nm on the molding surface. There was neither roughness nor gaps in the DLC:H film, and during continuous molding, optical elements were again obtained in the form of good molded products.

This process of 1,000 cycles of molding followed by regeneration processing consisting of acid cleansing, etching by hydrogen-based plasma, and DLC:H film formation was repeated 100 times. However, there was little actual surface deterioration of the molding surfaces of the pressing mold or decrease in ability to form a DLC:H film, and no problems with the quality of external appearance, such as clouding of the molded product, were encountered. The surface roughness of the molding surfaces following 100 cycles of regeneration processing was an Rmax (measured by AFM) of 30 nm.

### Comparative Example 1

Instead of etching the optical element pressing mold with a hydrogen-based gas plasma following 1,000 cycles of molding in Example 1, etching was conducted with oxygen gas plasma. As in Example 1, the acid-cleansed optical element pressing mold was placed on the base plate in the chamber of a plasma processing device, the interior of the chamber was evacuated to a vacuum of 5 Pa, and while introducing oxygen gas into the chamber to 5×10⁻³ Torr, electricity was discharged to generate a plasma. Etching by oxygen gas plasma was then conducted for 20 min. Observation of the molding surfaces by optical microscopy and SEM revealed no residue; the DLC:H film had been completely removed.

Further, after thoroughly cleansing the optical element pressing mold following this treatment, an ion-plating film-forming device was employed to form a DLC:H film to a thickness of 80 nm on the molding surfaces. When continuous molding of the same glass materials was begun, a defective external appearance such as clouding and fogging was exhibited on the molding surfaces after 30 pressing cycles. Observation of the molding surfaces after molding revealed separation of the DLC:H film.

### Comparative Example 2

Instead of etching the optical element pressing mold with a hydrogen-based gas plasma following 1,000 cycles of molding as in Example 1, etching was conducted with argon gas plasma. As in Example 1, the acid-cleansed optical element pressing mold was placed on the base plate in the chamber of a plasma processing device, the interior of the chamber was evacuated to a vacuum of 5 Pa, and while introducing argon gas into the chamber to 100 Pa, electricity was discharged to generate a plasma. Etching by argon gas plasma was then conducted for 300 min. Observation of the molding surfaces by optical microscopy and SEM revealed that the DLC:H film remained over the entirety of the molding surfaces.

Further, after thoroughly cleansing the pressing mold, an ion-plating film-forming device was employed to form a DLC:H film to a thickness of 80 nm on the molding surfaces. When continuous molding with the same glass materials was begun, defective external appearance such as clouding and fogging was exhibited by the molding surfaces after about 50 pressing cycles.

### Examples 2 to 6

With the exceptions that the base material of the mold, carbon-based mold separation film, method of forming the mold separation film, thickness of the mold separation film, optical glass, pressing conditions, cleansing prior to plasma treatment, and gas employed in etching (plasma source) were varied as indicated in Tables 1 and 2, regeneration processing was repeated 100 times in the same manner as in Example 1. As indicated in the tables, the actual surface deterioration on the molding surfaces of the pressing mold and decrease in the ability to form the carbon-based mold separation film were quite small. No problems were found with the quality of the external appearance of the molded products.

The lenses molded in Examples 2 to 6 were as follows.

Example 2: Concave meniscus lens with an outer diameter of 10 mm φ, center thickness of 0.5 mm, and edge thickness of 1.5 mm.

Example 3: Biconcave lens with an outer diameter of 12 mm φ, center thickness of 0.6 mm, and edge thickness of 1.6 mm.

Example 4: Convex meniscus lens with an outer diameter of 15 mm φ, center thickness of 1.5 mm, and edge thickness of 0.6 mm.

Example 5: Concave meniscus lens with an outer diameter of 16 mm φ, center thickness of 0.8 mm, and edge thickness of 1.8 mm.

Example 6: Convex meniscus lens with an outer diameter of 22 mm φ, center thickness of 1.8 mm, and edge thickness of 0.4 mm.

TABLE 1

| Item | Example 1 | Comp. Example 1 | Example 2 | Example 3 |
|---|---|---|---|---|
| Mold base material | SiC | SiC | WC | Stainless steel |
| Carbon-based mold | DLC:H | DLC:H | ta-C | DLC |
| separation film | | | | |
| Method of forming mold | Ion plating | Ion plating | FCA method | Sputtering |
| separation film | | | | |
| Optical glass (Tg/Ts) | Glass A | Glass A | Glass B | Glass C |
| | Barium borosilicate glass | Barium borosilicate glass | Borate glass (500° C./535° C.) | Phosphate glass |
| | (500° C./540° C.) | (500° C./540° C.) | | (365° C./403° C.) |
| Pressing* conditions | 620° C./1 min | 620° C./1 min | 600° C./2 min | 450° C./2 min |
| Cleansing process prior to | 20% acid ammonium | 20% acid ammonium | 10% KOH aqueous solution/ | None |
| plasma treatment | fluoride aqueous solution/30 min | fluoride aqueous solution/30 min | 5 min immersion | |
| | immersion | immersion | | |
| Plasma source gas | Hydrogen gas 3.5% | Oxygen gas | Hydrogen gas | Hydrogen gas 3.5% |
| | Argon gas 96.5% | | | Argon gas 96.5% |
| Results of regeneration | ⊚ | X | ⊚ | ◯ |
| process*** | | | | |

TABLE 2

| Item | Example 4 | Example 5 | Example 6 | Comp. Example 2 |
|---|---|---|---|---|
| Mold base material | WC | SiC | Crystallized glass** | SiC |
| Carbon-based mold | DLC | First layer: DLC:H | First layer: C | DLC:H |
| separation film | | Second layer: DLC | Second layer DLC:H | |
| Method of forming mold | Sputtering | First layer: ion plating | First layer: acetylene gas | Ion plating |
| separation film | | Second layer: sputtering | thermal decomposition | |
| | | | Second layer: ion plating | |
| Optical glass (Tg/Ts) | Glass D | Glass E | Glass C | Glass A |
| | Borate glass (520° C./ | Borate glass (560° C./600° C.) | Phosphate glass | Barium borosilicate glass |
| | 560° C.) | | (365° C./403° C.) | (500° C./540° C.) |
| Pressing* conditions | 620° C./1 min | 660° C./2 min | 450° C./2 min | 620° C./1 min |
| Cleansing process prior to | 5% acid ammonium | 5% acid ammonium fluoride | None | 20% acid ammonium |
| plasma treatment | fluoride aqueous solution/ | aqueous solution/10 min | | fluoride aqueous solution/30 min |
| | 10 min immersion | immersion | | immersion |
| Plasma source gas | Hydrogen gas 5% | Hydrogen gas | Hydrogen gas 3.5% | Argon gas |
| | Argon gas 95% | | Argon gas 96.5% | |
| Results of regeneration | ◯ | ⊚ | ◯ | X |
| process*** | | | | |

*Pressing pressure: 100 to 200 kg/cm²
**Crystron Zero made by HOYA (Ltd.)
***Results of regeneration process: External appearance of optical element through 100 cycles of regeneration processing of the same mold.
⊚: No clouding or fogging observed after 100 cycles of regeneration.
◯: Fewer than 30 cases of clouding or fogging after 100 cycles of regeneration.
X: Clouding and fogging after repeat regeneration.

### Example 7

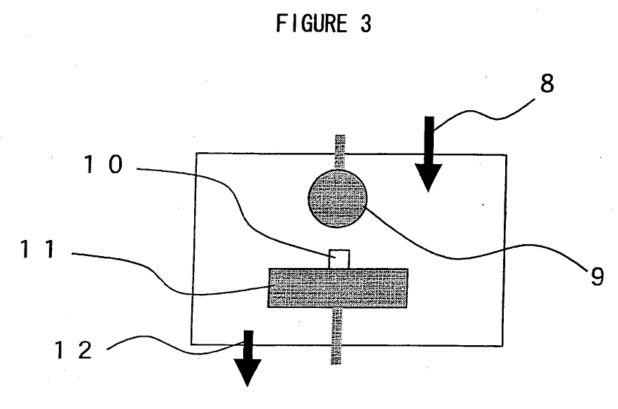

In Example 1, instead of etching the optical element pressing mold with hydrogen gas plasma after 1,000 pressing cycles, as shown in FIG. 3, the acid-cleansed optical element pressing mold was placed in a UV ozone treatment unit with a UV lamp having an output of 350 W, the interior of the chamber was evacuated to a vacuum of 10 Pa, oxygen gas was introduced until the interior of the chamber reached atmospheric pressure, the UV lamp was turned on, and UV ozone treatment was conducted for 20 min.

Observation of the molding surfaces by optical microscopy and SEM revealed no residue; the DLC:H film had been completely removed. Roughness measurement by AFM revealed an Rmax of 25 nm; the surface profile of the base material surface had been preserved.

After thoroughly cleansing the optical element pressing mold following this treatment, an ion plating mold-forming device was employed to form a DLC:H film to a thickness of 30 nm on the molding surface. There were no anomalies such as roughness or gaps in the DLC:H film, and during continuous molding, optical elements were again obtained in the form of good molded products.

This process of 1,000 cycles of molding followed by regeneration processing consisting of acid cleansing, etching by hydrogen-based plasma, and DLC:H film formation was repeated 100 times. However, there was little actual surface deterioration of the molding surfaces of the pressing mold or decrease in ability to form a DLC:H film. No problems with the quality of external appearance were encountered. The surface roughness of the molding surfaces following 100 cycles of regeneration processing was an Rmax (measured by AFM) of 31 nm.

### Comparative Example 3

Instead of processing the optical element pressing mold with UV ozone following 1,000 cycles of molding as in Example 7, heat processing was conducted for 30 min at 800° C. in an oxygen atmosphere. Observation of the molding surfaces by optical microscopy, scanning electron microscopy (SEM), and atomic force microscopy (AFM) revealed no residue; the DLC:H film had been completely removed. However, measurement of roughness by AFM revealed an Rmax of 128 nm; roughening of the base material molding surface had progressed.

Further, after thoroughly cleansing the pressing mold, an ion-plating film-forming device was employed to form a DLC:H film to a thickness of 30 nm on the molding surfaces. When continuous molding with the same glass materials was begun, defective external appearance such as clouding and fogging was exhibited by the molding surfaces in the first pressing cycle.

### Examples 8 to 12

With the exceptions that the base material of the mold, carbon-based mold separation film, method of forming the mold separation film, thickness of the mold separation film, optical glass, pressing conditions, cleansing prior to UV ozone treatment, and use or lack thereof of UV treatment were varied as indicated in Tables 3 and 4, regeneration processing was repeated 100 times in the same manner as in Example 7. As indicated in the tables, the actual surface deterioration on the molding surfaces of the pressing mold and decrease in the ability to form a carbon-based mold separation film were quite small. No problems were found with the quality of the external appearance of the molded products.

The lenses molded in Examples 8 to 12 were as follows.

Example 8: Concave meniscus lens with an outer diameter of 12 mm φ, center thickness of 0.8 mm, and edge thickness of 1.9 mm.

Example 9: Biconcave lens with an outer diameter of 8 mm φ, center thickness of 0.4 mm, and edge thickness of 1.2 mm.

Example 10: Convex meniscus lens with an outer diameter of 18 mm φ, center thickness of 1.8 mm, and edge thickness of 0.6 mm.

Example 11: Concave meniscus lens with an outer diameter of 12 mm φ, center thickness of 0.4 mm, and edge thickness of 1.8 mm.

Example 12: Biconvex lens with an outer diameter of 6 mm φ, center thickness of 1.2 mm, and edge thickness of 0.4 mm.

TABLE 3

| Item | Example 7 | Comparative Example 3 | Example 8 |
|---|---|---|---|
| Mold base material | SiC | SiC | Stainless steel |
| Carbon-based mold | DLC:H | DLC:H | DLC |
| separation film | | | |
| Method of forming mold | Ion plating | Ion plating | Sputtering |
| separation film | | | |
| Thickness of mold separation | 30 nm | 30 nm | 20 nm |
| film | | | |
| Optical glass (Tg/Ts) | Glass A | Glass A | Glass C |
| | Barium borosilicate glass | Barium borosilicate glass | Phosphate glass |
| | (500° C./540° C.) | (500° C./540° C.) | (365° C./403° C.) |
| Pressing* conditions | 620° C./1 min | 620° C./1 min | 450° C./2 min |
| Cleansing process prior to | 20% acid ammonium | 20% acid ammonium | None |
| UV ozone treatment | fluoride aqueous solution/30 min | fluoride aqueous solution/30 min | |
| | immersion | immersion | |
| Use or absence of UV ozone | Used 20 min in oxygen gas. | Not used. 30 min in oxygen | Used. Dried in air for 15 min |
| treatment | | gas. | |
| Base plate heating | None | 800° C. | None |
| Results of regeneration | ◯ | X | ◯ |
| process*** | | | |

*Pressing pressure: 100 to 200 kg/cm²

TABLE 4

| Item | Example 9 | Example 10 | Example 11 | Example 12 |
|---|---|---|---|---|
| Mold base material | WC | SiC | SiC | Crystallized glass*** |
| Carbon-based mold | ta-C | First layer: DLC:H | First layer: DLC:H | First layer: C |
| separation film | | Second layer: DLC | Second layer: ta-C | Second layer: DLC:H |
| Method of forming mold | Filtered cathodic arc (FCA) | First layer: ion plating | First layer: ion plating | First layer: acetylene gas |
| separation film | | Second layer: sputtering | Second layer: FCA | thermal decomposition |
| | | | | Second layer: ion plating |
| Thickness of mold | 80 nm | 160 nm | 120 nm | 200 nm |
| separation film | | | | |
| Optical glass (Tg/Ts) | Glass D | Glass E | Glass B | Glass C |
| | Borate glass | Borate glass | Borate glass | Phosphate glass |
| | (520° C./560° C.) | (560° C./600° C.) | (500° C./535° C.) | (365° C./403° C.) |
| Pressing* conditions | 620° C./1 min | 660° C./2 min | 620° C./1 min | 450° C./2 min |
| Cleansing process prior to | 5% acid ammonium fluoride | 5% acid ammonium fluoride | 20% acid ammonium | None |
| UV ozone treatment | aqueous solution/10 min | aqueous solution/10 min | fluoride aqueous solution/15 min | |
| | immersion | immersion | immersion | |
| UV ozone treatment | 30 min in oxygen gas. | 40 min in air | 30 min in dry air | 50 min in oxygen gas |
| Base plate heating | 400° C. | None | 300° C. | 300° C. |
| Results of regeneration | ⊚ | ◯ | ⊚ | ◯ |
| process*** | | | | |

*Pressing pressure: 100 to 200 kg/cm²
**Crystron Zero made by HOYA (Ltd.)
***Results of regeneration process: External appearance of optical element through 100 cycles of regeneration processing of the same mold.
⊚: No clouding or fogging observed after 100 cycles of regeneration.
◯: Fewer than 30 cases of clouding or fogging after 100 cycles of regeneration.
X: Clouding and fogging after repeat regeneration.

1-8. (Canceled)

9. A method of regenerating a pressing mold having a molding surface, said molding surface having a film containing carbon which is deteriorated by pressing, comprising:
removing the deteriorated film by etching with plasma of a gas containing hydrogen; and
forming a film containing carbon on the molding surface.

10. The method of claim 9 wherein the gas contains hydrogen and argon.

11. The method of claim 9 further comprising cleansing the molding surface with a solution of an acid or an alkali prior to the removing of the film.

12. A method of regenerating a pressing mold having a molding surface, said molding surface having a film containing carbon which is deteriorated by pressing, comprising:
removing the deteriorated film by a treatment with ozone; and
forming a film containing carbon on the molding surface.

13. The method of claim 12 wherein the ozone is generated by ultra-violet radiation.

14. The method of claim 13 wherein the pressing mold is heated to 100° C. to 600° C. when the treatment is carried out.

15. The method of claim 13 further comprising cleansing the molding surface with a solution of an acid or an alkali prior to the removing of the film.

16. A method of manufacturing an optical glass element with a pressing mold, said pressing mold having a molding surface comprising a film containing carbon, comprising:
press molding a heat-softened glass material with the pressing mold;
cooling the press molded glass material in the pressing mold; and
taking out the press molded glass material from the pressing mold,
wherein the pressing mold is regenerated by removing a film containing carbon by etching with plasma of a gas containing hydrogen, and forming the film containing carbon on the molding surface.

17. The method of claim 16 wherein the gas contains hydrogen and argon.

18. The method of claim 16 wherein the molding surface is cleansed with a solution of an acid or an alkali prior to the removing of the film.

19. A method of manufacturing an optical glass element with a pressing mold, said pressing mold having a molding surface comprising a film containing carbon, comprising:
press molding a heat-softened glass material with the pressing mold;
cooling the press molded glass material in the pressing mold; and
taking out the press molded glass material from the pressing mold,
wherein the pressing mold is regenerated by removing a film containing carbon by a treatment with ozone, and forming the film containing carbon on the molding surface.

20. The method of claim 19 wherein the ozone is generated by ultra-violet radiation.

21. The method of claim 19 wherein the pressing mold is heated to 100° C.

to 600° C. when the treatment is carried out.

22. The method of claim 19 wherein the molding surface is cleansed with a solution of an acid or an alkali prior to the removing of the film.

23. The method of claim 16 wherein the molding surface comprises a surface roughness of 20 nm or less in terms of Rmax.

24. The method of claim 16 wherein the optical element comprising phosphate glass, fluorophosphate, or borate glass.
